(19) United States
(12) Patent Application Publication
(10) Pub. No.: US 2025/0131252 A1
(43) Pub. Date: Apr. 24, 2025

(54) COMPUTING DEVICE, NEURAL NETWORK SYSTEM, NEURON MODEL DEVICE, COMPUTATION METHOD, AND TRAINED MODEL GENERATION METHOD

(71) Applicant: NEC Corporation, Minato-ku, Tokyo (JP)

(72) Inventor: Yusuke SAKEMI, Tokyo (JP)

(73) Assignee: NEC Corporation, Minato-ku, Tokyo (JP)

(21) Appl. No.: 18/684,943

(22) PCT Filed: Sep. 3, 2021
(86) PCT No.: PCT/JP2021/032453

§ 371 Date: Feb. 20, 2024

(51) Int. Cl. G06N 3/049

(52) U.S. Cl. CPC G06N 3/049

(57) ABSTRACT

A computing device includes a spiking neural network that includes an accumulation phase that adds currents and a decoding phase that converts a voltage resulting from the addition to a voltage pulse timing, the spiking neural network comprising a current adding portion wherein the current that flows into or out of an own neuron in the accumulation phase depends on the membrane potential of that neuron.

### TECHNICAL FIELD

This invention relates to a computing device, a neural network system, a neuron modeling device, a computation method, and a trained model generation method.

### BACKGROUND ART

One type of neural network is the spiking neural network (SNN). For example, Patent Document 1 describes a neuromorphic computing system that implements a spiking neural network on a neuromorphic computing device.

In spiking neural networks, neuron models have internal states called membrane potentials and output signals called spikes based on the temporal evolution of membrane potentials.

There is knowledge to realize such a neuron model using analog circuits, including analog sum-of-products operators. For example, by implementing operations such as taking the weighted sum of the output of an activation function or applying an activation function to a weighted sum using analog circuits, it is possible to enhance the efficiency of these computations. When using such an analog circuit, the circuit that converts the voltage to a pulse can be mapped to the activation function. As the subject of training becomes more complex with neural networks, the scale of the neural network tends to increase. Consequently, the configuration of spiking neural networks implemented with analog circuits may become complex.

### PRIOR ART DOCUMENTS

### Patent Document

Patent Document 1: Japanese Unexamined Patent Application, First Publication No. 2018-136919

### SUMMARY OF THE INVENTIONS

### Problems to be Solved by the Invention

It is desirable to be able to more simply construct each neuron model that makes up the spiking neural network.

An example of an object of the present invention is to provide a computing device, a neural network system, a neuron model device, a computation method, and a trained model generation method that can solve the above-mentioned problems.

### Means for Solving the Problem

According to the first example aspect of the invention, the computing device includes a spiking neural network that includes an accumulation phase that adds currents and a decoding phase that converts a voltage resulting from the addition to a voltage pulse timing, the spiking neural network including a current adding portion wherein the current that flows into or out of an own neuron in the accumulation phase depends on the membrane potential of that neuron.

According to the second example aspect of the invention, the neural network system is a neural network system that includes a spiking neural network that includes an accumulation phase that adds currents and a decoding phase that converts a voltage resulting from the addition to a voltage pulse timing, comprising a current adding portion wherein the current that flows into or out of an own neuron in the accumulation phase depends on the membrane potential of that neuron.

According to a third example aspect of the invention, the neuron model device is a neuron model device that forms a spiking neural network that includes an accumulation phase that adds currents and a decoding phase that converts a voltage resulting from the addition to a voltage pulse timing, including a current adding portion wherein the current that flows into or out of an own neuron in the accumulation phase depends on the membrane potential of that neuron.

According to the fourth example aspect of the invention, the computation method is a computation method using a spiking neural network that includes an accumulation phase that adds currents and a decoding phase that converts a voltage resulting from the addition to a voltage pulse timing, the method including a current adding computation wherein the current that flows into or out of an own neuron in the accumulation phase depends on the membrane potential of that neuron.

According to the fifth example aspect of the invention, the trained model generation method, in which a spiking neural network that includes an accumulation phase that adds currents and a decoding phase that converts a voltage resulting from the addition to a voltage pulse timing includes a current adding computation wherein the current that flows into or out of an own neuron in the accumulation phase depends on the membrane potential of that neuron, the trained model generation method being one for determining the responsiveness of the membrane potential of the own neuron to the current.

### Effect of Invention

According to the present invention, each neuron model comprising a computing device can be configured more simply.

### BRIEF DESCRIPTION OF THE DRAWINGS

FIG. 1 is a diagram showing an example of the configuration of a neural network device according to the example embodiment.

FIG. 2 is a diagram showing an example of the configuration of a spiking neural network equipped with a neural network device according to the example embodiment.

FIG. 3A is a diagram showing an example of the temporal variation of the membrane potential in a spiking neuron model in which the timing of the spike signal output is not restricted according to the example embodiment.

FIG. 3B is a diagram for illustrating the method of computing the membrane potential of the target model using a deep learning model of a comparative example.

FIG. 3C is a diagram for illustrating the method of computing the membrane potential of the target model using an analog circuit.

FIG. 3D is a diagram for illustrating the procedure for converting the membrane potential of the target model into a pulse using an analog circuit.

FIG. 3E is a diagram for illustrating the method of computing the membrane potential of the target model using an analog circuit.

FIG. 4 is a configuration diagram of the spiking neuron model including the analog product-sum computation circuit.

FIG. 5A is a diagram showing an example of the timing of passing spike signals between neuron models in the neural network device according to the example embodiment.

FIG. 5B is a diagram showing an example of the timing of passing spike signals between neuron models in the neural network device according to the example embodiment.

FIG. 6 is a diagram showing an example of the setting of a time interval according to the example embodiment.

FIG. 7 is a diagram showing an example of setting the firing limit of the neuron model 100 according to the example embodiment.

FIG. 8A is a diagram illustrating the response of the neuron model 100 of the example embodiment.

FIG. 8B is a diagram for illustrating the response of the neuron model 100 of the example embodiment.

FIG. 8C is a diagram for illustrating the response of the neuron model 100 of the example embodiment.

FIG. 8D is a diagram for illustrating the analysis accuracy of the neuron model 100 of the example embodiment.

FIG. 9 is a diagram showing an example of the system configuration during training in the example embodiment.

FIG. 10 is a diagram showing an example of signal input/output in the neural network system 1 according to the example embodiment.

FIG. 11 is a diagram showing an example of signal input/output in the neural network device during operation in the example embodiment.

FIG. 12 is a diagram showing an example of the configuration of the neural network device according to the example embodiment.

FIG. 13 is a diagram showing an example of the configuration of the neuron model device according to the example embodiment.

FIG. 14 is a diagram showing an example of the configuration of the neural network system according to the example embodiment.

FIG. 15 is a flowchart showing an example of the processing procedure in the computation method according to the example embodiment.

FIG. 16 is a schematic block diagram showing the configuration of a computer according to the example embodiment.

### EXAMPLE EMBODIMENT

The following is a description of an example embodiment of the present invention, but the following example embodiment is not limiting to the claimed invention. Not all of the combinations of features described in the example embodiment are essential to the solution of the invention.

### Example Embodiment

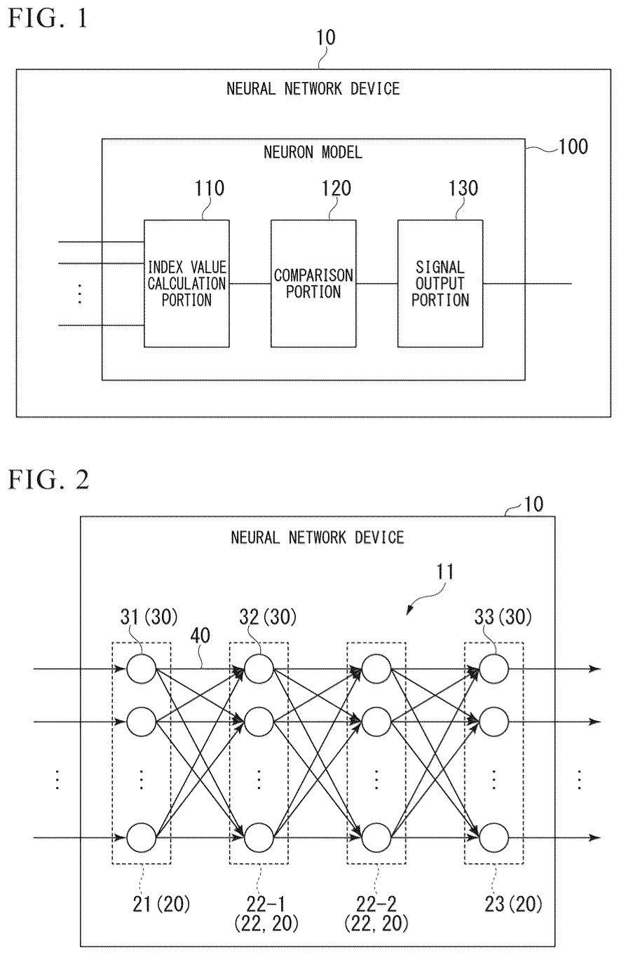

FIG. 1 is a diagram showing an example of the configuration of a neural network device according to the example embodiment. In the configuration shown in FIG. 1, a neural network device 10 (computing device) includes a neuron model 100. The neuron model 100 includes an index value calculation portion 110, a comparison portion 120, and a signal output portion 130.

The neural network device 10 uses a spiking neural network to process data. The neural network device 10 is an example of a computing device.

A neural network device here is a device in which a neural network is implemented. The spiking neural network may be implemented in the neural network device 10 using dedicated hardware. For example, a spiking neural network may be implemented in the neural network device 10 using an Application Specific Integrated Circuit (ASIC) or Field Programmable Gate Array (FPGA). Alternatively, the spiking neural network may be implemented on the neural network device 10 using a computer or similar means, even in a software-based manner.

Devices with ASICs, devices with FPGAs, and computers are all examples of programmable devices. In ASICs and FPGAs, describing hardware using a hardware description language and realizing the described hardware on an ASIC or FPGA is an example of programming. When the neural network device 10 is configured using a computer, the functions of the spiking neural network may be described by programming and the resulting program may be executed by a computer. The following is an example of a spiking neural network realized using analog circuits and implemented in the neural network device 10. In that explanation, when describing the functional composition, there may be instances where an example of the configuration of the functional model (numerical analysis model) is provided for clarification.

A spiking neural network is a neural network that outputs signals with a timing based on a state quantity called membrane potential, in which the output state of a neuron model varies with time according to the input status of a signal to the neuron model itself. The membrane potential is also referred to as the index value of the signal output or simply the index value.

Time variation here refers to the change with time.

Neuron models in spiking neural networks are also referred to as spiking neuron models. The signals output by the spiking neuron model are also referred to as spiking signals or spikes. In spiking neural networks, binary signals can be used as spike signals, and information can be transferred between spiking neuron models by the timing of spike signal transmission or the number of spike signals.

In the case of the neuron model 100, an index value calculation portion 110 calculates the membrane potential based on the input status of the spike signal to the neuron model 100. A signal output portion 130 outputs a spike signal at a timing corresponding to the time variation of the membrane potential.

Regarding spike signals in the neural network device 10, it is permissible to use pulse signals, and it is also permissible to use step signals, but it is not limited thereto.

In the following, an example will be described of using a temporal method that transmits information at the timing of spike signal transmission as the information transmission method between neuron models 100 in a spiking neural network by the neural network device 10. However, the information transmission method between the neuron models 100 in the spiking neural network by the neural network device 10 is not limited to any particular method.

The processing performed by the neural network device 10 can be a variety of processes that can be executed using spiking neural networks. For example, the neural network device 10 may perform, but is not limited to, image recognition, biometric identification or numerical prediction.

The neural network device 10 may be configured as a single device or a combination of a plurality of devices. For example, a spiking neural network may be constituted by the individual neuron models 100 being configured as devices, and connecting the devices constituting these individual neuron models 100 by signal transmission pathways.

FIG. 2 is a diagram showing an example of the configuration of a spiking neural network provided by the neural network device 10. The spiking neural network provided by the neural network device 10 is also denoted as a neural network 11. The neural network 11 is also referred to as a neural network body.

In the example in FIG. 2, the neural network 11 is configured as a feed-forward four-layer spiking neural network. Specifically, the neural network 11 includes an input layer 21, two intermediate layers 22-1 and 22-2, and an output layer 23. The two intermediate layers 22-1 and 22-2 are also collectively referred to as intermediate layers 22. The intermediate layers are also referred to as hidden layers. The input layer 21, intermediate layers 22, and output layer 23 are also collectively referred to as layers 20.

The input layer 21 includes an input node 31. The intermediate layers 22 include an intermediate node 32. The output layer 23 includes an output node 33. The input node 31, intermediate node 32, and output node 33 are also collectively denoted as nodes 30.

The input node 31, for example, converts input data to the neural network 11 into spike signals. Alternatively, if the input data to the neural network 11 is indicated by spike signals, the neuron model 100 may be used as the input node 31.

Any of the neuron models 100 may be used as the intermediate node 32 and output node 33. The behavior of the neuron model 100 may differ between the intermediate node 32 and output node 33, such as the constraints on spike signal output timing described below being more relaxed at the output node 33 than at intermediate node.

The four layers 20 of the neural network 11 are arranged in the following order from upstream in signal transmission: the input layer 21, the intermediate layer 22-1, the intermediate layer 22-2, and the output layer 23. Between two adjacent layers 20, the nodes 30 are connected by a transmission path 40. The transmission path 40 transmits spike signals from the node 30 in the upstream layer 20 to the node 30 in the downstream layer 20.

However, when the neural network 11 is configured as a forward propagating spiking neural network, the number of layers is not limited to four, but can be two or more. The number of neuron models 100 that each layer has is not limited to a specific number; each layer can have one or more neuron models 100. Each layer may have the same number of neuron models 100, or different layers may have different numbers of neuron models 100.

The neural network 11 may be configured in an all-coupled configuration, but is not limited thereto. In the example in FIG. 2, all neuron models 100 in the layer 20 on the front side and all neuron models 100 in the layer 20 on the back side in adjacent layers may be coupled by transmission paths 40, but some of the neuron models 100 in adjacent layers may not be coupled to each other by the transmission paths 40.

In the description below, the delay time in the transmission of spike signals is assumed to be negligible, and the spike signal output time of the neuron model 100 on the spike signal output side and the spike signal input time to the neuron model 100 on the spike signal input side are assumed to be the same. If the delay time in spike signal transmission is not negligible, the spike signal output time plus the delay time may be used as the spike signal input time.

The spiking neuron model outputs a spike signal when the time-varying membrane potential reaches a threshold value within a given period of time. In a typical spiking neural network where the output timing of spike signals is not restricted, when there are a plurality of data to be processed, it is necessary to wait for the input of the next input data to the spiking neural network until the spiking neural network receives an input of input data and outputs the computation result.

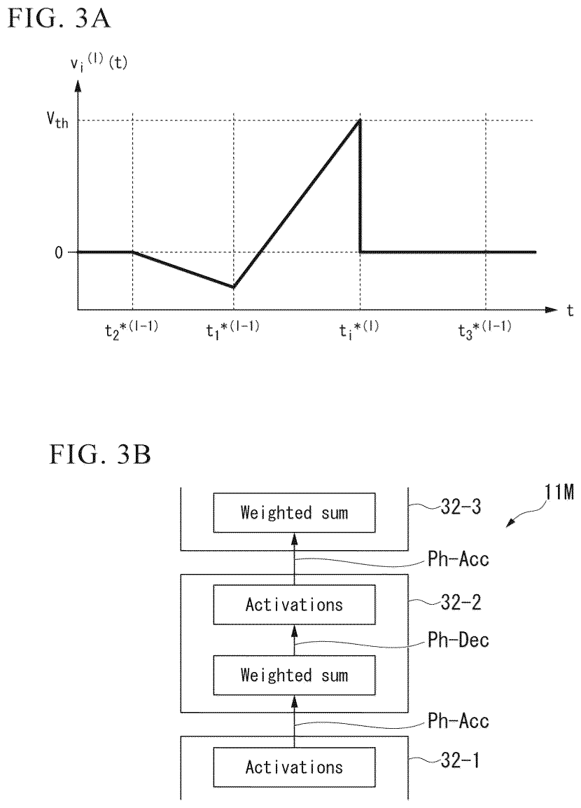

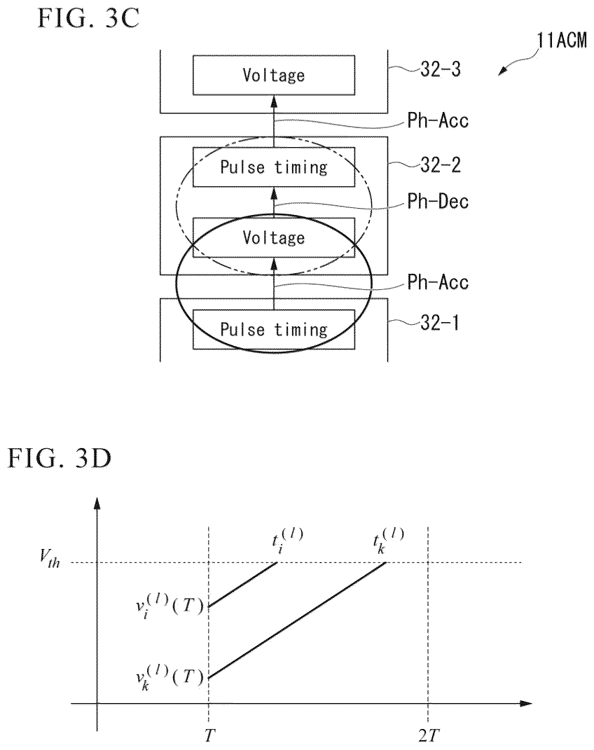

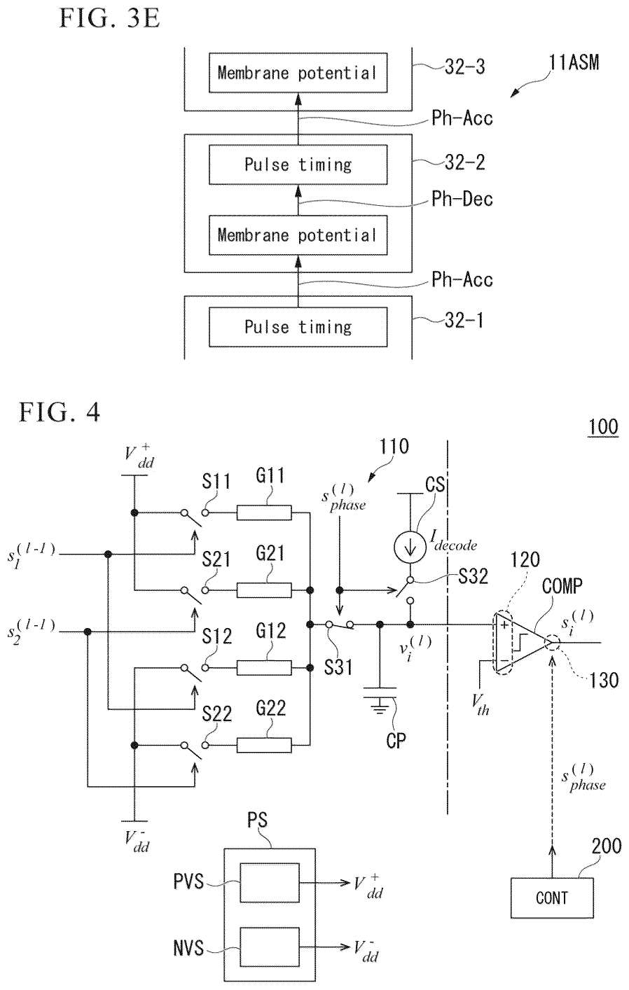

FIG. 3A is a diagram showing an example of the time variation of the membrane potential in a spiking neuron model in which the output timing of the spike signal is not restricted. The horizontal axis of the graph in FIG. 3A shows time. The vertical axis indicates membrane potential.

FIG. 3A shows an example of the membrane potential of a spiking neuron model of the i-th node in layer l. The membrane potential at time t of the spiking neuron model of the i-th node in layer l is denoted as vi(l)(t). The spiking neuron model of the i-th node in layer l is also referred to as the target model in the description of FIG. 3A. Time t indicates the elapsed time starting from the start time of the time interval allocated to the processing of the first layer.

In the example in FIG. 3A, the target model is receiving spiking signal inputs from three spiking neuron models.

Time t2*(l−1) indicates the input time of the spike signal from the second spiking neuron model in layer l−1. Time t1*(l−1) indicates the input time of the spike signal from the first spiking neuron model in layer l−1. Time t3*(l−1) indicates the input time of the spike signal from the third spiking neuron model in layer l−1.

The target model also outputs a spike signal at time ti*(l). The spiking neuron model's output of a spike signal is referred to as firing. The time at which the spiking neuron model fires is referred to as the firing time.

In the example in FIG. 3A, the initial value of the membrane potential is set to 0. The initial value of the membrane potential corresponds to the resting membrane potential.

Before the target model fires, the membrane potential vi(l)(t) of the target model continues to change at a rate of change (change rate) according to the weight set for each spike signal transmission path after the spike signal is input. The rate of change of the membrane potential for each spike signal input is linearly additive. The differential equation for the membrane potential vi(l)(t) in the example in FIG. 3A is expressed as in Equation (l).

$$\begin{matrix}[ Equation 1 ] & \\ \frac{d}{dt} {v}_{i}^{( l )} ( t ) = {\sum }_{j} {w}_{ij}^{( l )} θ ( t - {t}_{j}^{* ( l - 1 )} ) & ( 1 )\end{matrix}$$

$$θ ( x ) = \{ \begin{matrix}0 , & ( x < 0 ) \\ 1 , & ( x ≧ 0 )\end{matrix} \qquad ( 2 )$$

In Equation (l), wij(l) denotes the weight set on the transmission path of the spike signal from the j-th spiking neuron model in layer l−1 to the target model. The weight wij(l) is the subject to training. The weight wij(l) can take both positive and negative values.

θ is a step function and is shown in Equation (2). Therefore, the rate of change of the membrane potential vi(l)(t) changes while showing various values depending on the input status of the spike signal and the value of the weight wij(l), taking both positive and negative values in the process.

For example, at time ti*(l), the membrane potential vi(l)(t) of the target model reaches the threshold Vth and the target model fires. The firing causes the membrane potential vi(l)(t) of the target model to be zero, and thereafter the membrane potential remains unchanged even when the target model receives a spike signal input.

Referring to FIG. 3B through FIG. 3D, the above method of computing the membrane potential of the target model is explained. FIG. 3B illustrates the computation method for obtaining the membrane potential of the target model using a deep learning model 11M as the numerical analysis model in the comparison example. FIG. 3C illustrates the computation method for obtaining the membrane potential of the target model using the analog circuit of the example embodiment. FIG. 3D is a diagram illustrating how an analog circuit is used to convert the membrane potential of the target model into a pulse.

In the case of the comparative example using the deep learning model 11M shown in FIG. 3B, the operation of taking a weighted sum of the outputs of the activation function (weighted sum) and applying the activation function to the weighted sum (activation) are performed repeatedly. For example, the deep learning model 11M includes intermediate nodes 32-1, 32-2, and 32-3 in different layers from each other. The intermediate nodes 32-1, 32-2 and 32-3 are examples of an intermediate node 32. If the intermediate node 32-1 and the intermediate nodes 32-2 and 32-3 are connected in series in the order of signal processing, then when the intermediate node 32-1 performs the operation of applying the activation function, the intermediate node 32-2 performs the operation of taking a weighted sum of the outputs of the activation function. Then, when the intermediate node 32-2 performs the operation of applying that activation function, the intermediate node 32-3 in the next layer accordingly performs the operation of taking a weighted sum of the outputs of the activation function. In the comparative example, the above computation is performed by numerical analysis.

In contrast, the following describes a case in which the above computation is realized using an analog circuit 11ACM.

The analog circuit 11ACM shown in FIG. 3C is an example of one that prioritizes training with greater accuracy. In the case of the method using the analog circuit 11ACM, an accumulation phase (Ph-Acc) that operates a voltage related to the membrane potential is employed instead of the operation that take a weighted sum of the outputs of the activation function (weighted sum), and a decoding phase (Ph-Dec) that determines the pulse timing with respect to the membrane potential is employed instead of the operation of applying an activation function to the weighted sum (activation). These phases are repeated. For example, between the intermediate nodes 32-1 and 32-2 in mutually different layers, the accumulation phase that manipulates the voltage with respect to the membrane potential of the intermediate node 32-2 is applied, and between the intermediate nodes 32-2 and 32-3 in mutually different layers, a decoding phase that determines the pulse timing with respect to the membrane potential of intermediate node 32-2 is applied.

The graph in FIG. 3D shows an example of a conversion rule that converts voltages to pulses.

The graph in FIG. 3D shows the relationship between voltage (vertical axis) and change over time (horizontal axis). It indicates that, over a predetermined period from time T to time 2T, a spike signal is output when the voltage (membrane potential), which changes monotonically with time, reaches the threshold value Vth. For example, the graph shown in FIG. 3D describes two straight lines with different membrane potentials from each other at the start stage of the decoding phase. The graph in FIG. 3D shows an example of an activation function.

By the way, in the case of the method using the analog circuit 11ACM shown in FIG. 3C, it is possible to select an operation circuit that calculates the membrane potential by exact arithmetic. It is possible to make a selection from an example of integrating a current from a constant voltage source with a product-sum computation circuit using an operational amplifier and a capacitor in its feedback circuit, an example of integrating with an integrating circuit that charges a capacitor with current from a constant current source, and the like. In the case of such an analog circuit 11ACM, an operational amplifier, constant-current circuit, etc., are required within the scope of the circuits utilized in the accumulation phase described above. These configurations, for example, were required for each of the intermediate nodes 32, which led to an increase in the size of the circuit.

The method of using the analog circuit 11ASM shown in FIG. 3E prioritizes a more concise configuration. The method using the analog circuit 11ASM is similar to the method using the analog circuit 11ACM shown in FIG. 3C above, but differs in some respects. The difference is that instead of calculating the voltage related to the membrane potential during the accumulation phase, the membrane potential is calculated directly. The analog circuit 11ACM calculates directly by using an integrating circuit that charges the current from a constant voltage source (power supply PS) to the capacitor CP. The direct calculation method includes obtaining the membrane potential without involving conversion of the current due to the spike signal using active elements.

The above computation method using a spiking neural network includes an accumulation phase to add currents and a decoding phase to convert the resulting voltage to voltage pulse timing. The computation method is configured so as to include a current adding computation in which the current flowing into or out of the neuron model 100 during the accumulation phase depends on the membrane potential of that neuron model 100.

The following describes an example of the analog circuit 11ASM that implements such a spiking neuron model. The analog circuit 11ASM is one that realizes an analog product-sum computation circuit that does not utilize the operational amplifier and constant current required in the accumulation phase of the method in FIG. 3C.

FIG. 4 is a configuration diagram of the spiking neuron model including the analog product-sum computation circuit.

The neuron model 100 is an example of a spiking neuron model that includes an analog product-sum computation circuit. For example, the neuron model 100 includes conductors G11-G22, switch S11 and switch S12, switches S21-S22, S31-S32, capacitor CP, constant current source CS, and comparator COMP.

The neuron model 100 may further have a positive power supply PVS and a negative power supply NVS inside it, or outside the neuron model 100. The positive power supply unit PVS and the negative power supply unit NVS are sometimes collectively referred to as the power supply unit PS.

The cathode power supply unit PVS is a voltage source capable of outputting a predetermined positive voltage Vdd+ relative to the reference potential as the reference positive voltage. The anode power supply unit NVS is a voltage source capable of outputting a predetermined negative voltage Vdd− relative to the reference potential as the reference negative voltage. The positive voltage Vdd+ and the negative voltage Vdd− are voltages within the allowable input voltage range of the comparator COMP, which is described below. The positive voltage Vdd+ and the negative voltage Vdd− are voltages within the supply voltage range of the comparator COMP (the range from the negative voltage VSS to the positive voltage VDD) (negative voltage VSS <negative voltage Vdd−<0 (reference potential)<positive voltage Vdd+<positive voltage VDD). The negative voltage VSS and the positive voltage VDD may be the supply voltage for the comparator COMP, which is described below.

The conductors G11-G22 may be formed by applying resistors individually, and may also be formed by applying semiconductor devices such as analog memories. For example, the conductances of the conductors G11, G12, G21, and G22 may be represented as σi1(l)+, σi1(l)−, σi2(l)+, and σi2(l)−, respectively. These are collectively called conductance values. Conductance is the reciprocal of resistance.

The switch S11 and switch S12, switch S21 and switch S22, and switch S31 and switch S32 each contain an a-contact type switch (semiconductor switch) that closes the circuit between the first and second terminals under control.

The switch S11 and switch S21 have their first terminals connected to the output of the positive power supply PVS.

The second terminal of the switch S11 is connected to the first terminal of the switch S31 via the series-connected conductor G11. The second terminal of the switch S12 is connected to the first terminal of the switch S31 via the series-connected conductor G12.

The switches S12 and S22 have their first terminals connected to the output of the negative power supply NVS.

The second terminal of the switch S12 is connected to the first terminal of the switch S31 via the series-connected conductor G12. The second terminal of the switch S22 is connected to the first terminal of the switch S31 via the series-connected conductor G22.

The control terminals of switches S11 and S12 are connected to the output of the neuron NNJ1 in layer (l−1). The switches S11 and S12 are switched on and off according to the logic state of the output signal S1 (l−1) of the neuron NNJ1 in layer (l−1). For example, the switches S11 and S12 both turn ON when the logic state of the output signal S1 (l−1) is 1 and OFF when it is 0. The 1 and 0 logic states of the output signal S1 (l−1) may be specified in correspondence with the result of having the voltage of the signal identified using a predetermined threshold voltage.

The control terminals of the switch S21 and switch S22 are connected to the output of neuron NNJ2 in layer (l−1). The switches S21 and S22 are switched on and off according to the logic state of the output signal S2 (l−1) of the neuron NNJ2 in layer (l−1). For example, the switches S21 and S22 both turn ON when the logic state of the output signal S2 (l−1) is 1 and OFF when it is 0. The 1 and 0 logic states of the output signal S2 (l−1) may be specified in correspondence with the result of having the voltage of the signal identified using a predetermined threshold voltage.

The second terminal of the switch S31 is connected to the first terminal of the capacitor CP, the first terminal of the switch S32, and the non-inverting input terminal of the comparator COMP. The voltage at the non-inverting input terminal of the comparator COMP is equal to the voltage at the first terminal of the capacitor CP.

The second terminal of the capacitor CP is connected to the pole of the reference potential. The output of the constant current source CS is connected to the second terminal of the switch S32. For example, a predetermined positive voltage is supplied to the power supply side of the constant current source CS. The constant-current source CS includes a constant-current circuit that flows a current Idecode with a regulated current value. The magnitude of the current Idecode is determined based on the capacitance C of the capacitor CP and the period T, which may be, for example, (C/T).

The control terminals of the switches S31 and S32 are supplied with the phase switching signal Sphase (l), a logic signal, from the controller 12. The switch S31 turns ON and OFF according to the logic state of the phase switching signal No. Sphase (l). For example, the switch S31 turns ON when the phase switching signal No. Sphase (l) is true in the first phase and turns OFF when the phase switching signal No. Sphase (l) is false in the second phase. In contrast, the switch S32 turns OFF when the phase switching signal No. Sphase (l) is true in the first phase and turns ON when the phase switching signal No. Sphase (l) is false in the second phase. The first phase is an example of the accumulation phase described above, and the second phase is an example of the decoding phase described above.

A threshold voltage Vth, which indicates a predetermined potential, is applied to the inverting input terminal of the comparator COMP. The comparator COMP compares the voltage vi(l) at the non-inverting input terminal with the threshold voltage Vth and outputs the comparison result as output signal Si(l). For example, the comparator COMP outputs the output signal Si(l) indicating “true” when the voltage vi(l) exceeds the threshold voltage Vth, and outputs the output signal Si(l) indicating “false” when the voltage vi(l) has not reached the threshold voltage Vth.

In the neuron model 100 constructed above, the membrane potential vi(l)(t) varies depending on the combination of the conductance values of the conductors G11-G22 and the period during which the switches S11-S22 are in the conducting state.

A discharge circuit for resetting the membrane potential vi(l)(t) to 0 may be provided in parallel with the capacitor CP, and the capacitor CP may be discharged at a predetermined timing controlled by the controller 12 or synchronized with a supplied clock.

As described above, the neuron model 100 forms a spiking neural network that includes an accumulation phase in which currents are added and a decoding phase in which the voltage produced by the addition is converted to a voltage pulse timing. The neuron model 100 is formed with an index value calculation portion 110 in which the current flowing into or out of the neuron model 100 (own neuron) during the accumulation phase depends on the membrane potential of the neuron model 100.

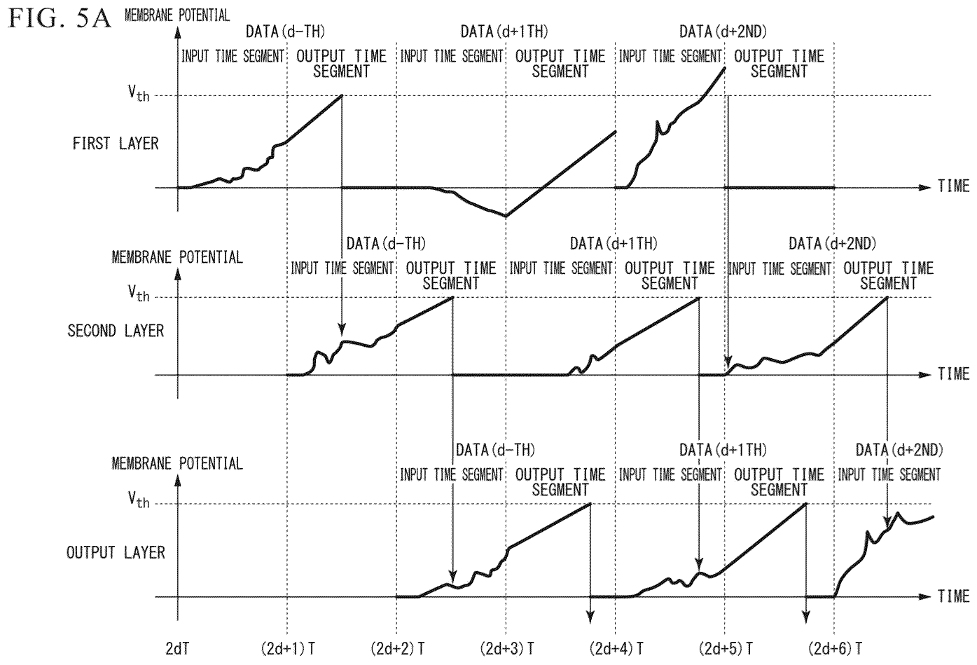

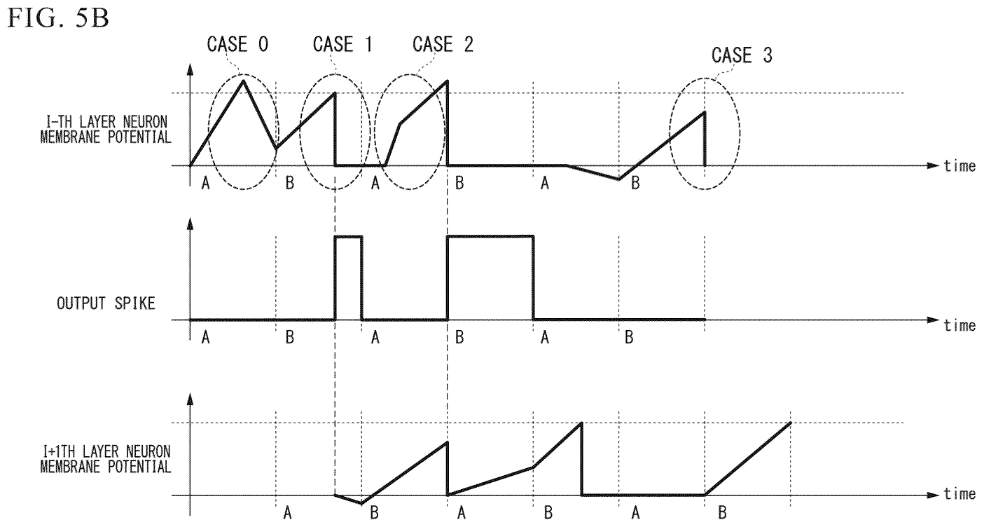

FIGS. 5A and 5B are diagrams show examples of the timing of spike signal passing between neuron models 100 in the neural network device 10. FIG. 5A shows, for each of the first through third layers of the neural network 11, examples of the time variation of the membrane potentials of each neuron model 100 related to passing the spike signal, and the firing timing based on those membrane potentials. The horizontal axis of the graph in FIG. 5A shows the time, i.e., the time elapsed since the first input data was input to the first layer. The vertical axis shows the membrane potential of each of the neuron models 100 from the first layer to the third layer.

In the example in FIG. 5A, the data processing time set for the neuron model 100 consists of a combination of input time intervals and output time intervals. The input time interval is the time interval during which the neuron model 100 accepts spike signal input. The output time interval is the time interval during which the neuron model 100 outputs spike signals.

The neural network device 10 sets the same input time interval and the same output time interval by synchronizing between the neuron models 100 in each layer so that all the neuron models 100 included in the same layer have the same data processing time. T is the time width of each time interval.

The neural network device 10 also synchronizes between layers so that the output time interval in the neuron model 100 in one layer overlaps with the input time interval in the neuron model 100 in the next layer.

In particular, the input time intervals and output time intervals are set so that the time length of the input time interval and the time length of the output time interval are the same, and the output time interval in the neuron model 100 in one layer completely overlaps the input time interval in the neuron model 100 in the next layer.

In this case, the “neuron model 100 of a layer” corresponds to the example of the first neuron model. The “neuron model 100 of the next layer” corresponds to an example of the second neuron model. The output time interval and input time interval are set so that the output time interval of the first neuron model overlaps with the input time interval of the second neuron model that receives spike signal input from the first neuron model.

With the time when spike signals are input to the neuron model 100 limited to the input time interval, the index value calculation portion 110 calculates the membrane potential so that the membrane potential is time-varying based on the input status of the spike signal in the input time interval. The index value calculation portion 110 corresponds to an example of an index value calculation means.

In the following, as in the description of the spiking neural network with reference to Equations (1) and (2), the neuron model 100 of the i-th node in layer l is referred to as the target model, and the membrane potential of the target model is denoted as vi(l)(t).

The indicator value calculation portion 110 uses the following Equation (1A) instead of the aforementioned Equation (1). Equation (1A) can be used to change the rate of change of the membrane potential vi(l)(t) between the input time interval and output time interval.

$$\begin{matrix}[ Equation 2 ] & \\ \frac{d}{dt} {v}_{i}^{( l )} ( t ) = \{ \begin{matrix}{\sum }_{j}^{N} {w}_{ij}^{( l )} ( 1 - {v}_{i}^{( l )} {V}_{syn}^{ij} ) θ ( t - {t}_{j}^{( l - 1 )} ) , & when ( l - 1 ) ≦ t < l \\ 1 , & when l ≦ t < ( l + 1 )\end{matrix} & ( 1 A )\end{matrix}$$

wij(l) denotes the weight set in the transmission path of the spike signal from the j-th spiking neuron model in layer l−1 to the target model. The rate of change of the membrane potential vi(l)(t) while the time t changes from (l−1) to 1 is a function using the weight coefficient wij(l). The rate of change of the membrane potential vi(l)(t) in the input time interval is then calculated by a function using the weight coefficient wij(l). The rate of change of the membrane potential vi(l)(t) during the output time interval in which the time t changes from 1 to (l+1) is a function using a weight coefficient or a fixed value. For example, its fixed value is positive. Its value may be 1. This is calculated using 1 as the rate of change of the membrane potential vi(l)(t) in the output time interval. The weight wij(l) should be made the target of the training. The weight set for the transmission path of the spike signal from the j-th spiking neuron model in layer l−1 to the target model is denoted as wij(l).

Equation (1A) above gives the rate of change of the membrane potential vi(l)(t). A detailed explanation of the above Equation (1A) is given below.

The term for the membrane potential vi(l) is included in the right-hand side of the equation for the input time interval in Equation (1A) above. This indicates that the rate of change of the membrane potential vi(l)(t), which is the left-hand side of this equation, varies with the membrane potential vi(l). A circuit that can eliminate the term of the membrane potential vi(l) on the right-hand side would be more complex than the configuration shown in FIG. 4, and the larger the scale, the more difficult it would be to realize.

The description relating to the neuron model 100 of the target model applies to all neuron models 100 provided by the neural network device 10, except that the output timing of the spike signal of the neuron model 100 in the output layer, which is discussed below, can be relaxed. That is, layer l may be any layer that includes the neuron model 100 as a node. Any neuron model 100 in layer l may be the i-th neuron model 100.

Using Equation (1A), it can be formulated that the membrane potential vi(l)(t) of the neuron model 100 varies in the output time interval with a slope specific to the output time interval. This slope is +1. This corresponds to the conversion characteristic shown in FIG. 3D above.

The firing time at which the neuron model 100 fires within the output time interval may be specified as a function of the membrane potential of the neuron model 100 at the last time of the input time interval. The neuron model 100 may be formed so as to limit firing when the membrane potential of the neuron model 100 at the last time of the input time interval is outside a predetermined range. The neuron model 100 may be formed such that the membrane potential of the neuron model 100 within the output time interval increases by a slope inherent to the neuron model 100. The neuron model 100 generates a spike of a predetermined pulse waveform when the membrane potential of the neuron model 100 meets a predetermined condition within the output time interval. For example, the neuron model 100 can start transmitting spikes in the form of square waves when the membrane potential of the neuron model 100 meets a predetermined condition within the output time interval, and interrupt the transmission of the spikes at the time when the output time interval ends.

Instead, a similar function can be achieved by fixing the membrane potential in the output time interval and varying the firing threshold value instead of the threshold value Vth. Specifically, for each neuron model, the firing threshold should be a unique value determined for each neuron model, and the firing threshold should be varied by slope of −1 during the output time interval. In the following description, the case in which the firing threshold is fixed to the threshold value Vth and the membrane potential vi(l)(t) changes during the output time interval is illustrated, but the same argument is applicable to the case in which the membrane potential is fixed and the firing threshold changes during the output time interval.

The following is a detailed description of the membrane potential vi(l)(t), divided into input and output time intervals. Below, the time evolution of the membrane potential vi(l)(t) based on the circuit shown in FIG. 4 is equivalent to Equation (1A) above.

The rate of change of the membrane potential vi(l)(t) is specified by dividing it into a first phase and a second phase depending on the range of time t. The rate of change of the membrane potential vi(l)(t) in the first phase is defined using Equation (3A), and the rate of change of membrane potential vi(l)(t) in the second phase is defined using Equation (3B).

The membrane potential vi(l)(t) of the input time interval is expressed as in Equation (3A). The membrane potential vi(l)(t) of the output time interval is expressed as in Equation (3B).

$$\begin{matrix}[ Equation 3 ] & \\ & \end{matrix}$$

$$C \frac{d}{dt} {v}_{i}^{( l )} ( t ) = \{ \begin{matrix}{\sum }_{j}^{N} {σ}_{ij}^{( l ) +} ( {V}_{dd}^{+} - {v}_{i}^{( l )} ) θ ( t - {t}_{j}^{( l - 1 )} ) + & when ( l - 1 ) T ≦ t < lT & ( 3 A ) \\ {σ}_{ij}^{( l ) -} ( {V}_{dd}^{-} - {v}_{i}^{( l )} ) θ ( t - {t}_{j}^{( l - 1 )} ) , & & \\ \frac{C}{T} , & when lT ≦ t < ( l + 1 ) T & ( 3 B )\end{matrix}$$

First, with reference to Equation (3A), the change in the membrane potential in the first phase will be described.

The variable σij(l)+ and the variable σij(l)− in Equation (3A) are explained below.

The variable σij(l)+ and the variable σij(l)− indicate the conductance components of the circuit in which the i-th neuron in layer l in the neuron model 100 receives the pulse signal from the j-th neuron in layer (l−1). The variable σij(l)+ and variable σij(l)− are shown in the following Equations (4A) and (4B).

$$\begin{matrix}[ Equation 4 ] & \\ {σ}_{ij}^{( l ) +} = \frac{{Cw}_{ij}^{( l )} {δ}_{{w}_{ij}^{( l )} ≧ 0}}{{V}_{dd}^{+}} & ( 4 A )\end{matrix}$$

$${σ}_{ij}^{( l ) -} = \frac{{Cw}_{ij}^{( l )} {δ}_{{w}_{ij}^{( l )} < 0}}{{V}_{dd}^{-}} \qquad ( 4 B )$$

The variable σij(l)+ shown in Equation (4A) above is the conductance component from the positive voltage source PVS to the i-th neuron. For example, the variable σij(l)+ is converted using capacitance C, the weight coefficient Wij(l), the function δ, and the positive voltage Vdd+. The variable σij(l)+ can be obtained by dividing the product of the capacitance C, the weight coefficient Wij(l), and the function δ by the positive voltage Vdd+.

The variable σij(l)− shown in Equation (4B) above is the conductance component from the negative voltage source NVS to the i-th neuron. For example, the variable σij(l)− is converted using the capacitance C, the weight coefficient Wij(l), the function δ, and the negative voltage Vdd−. The variable σij(l)− can be obtained by dividing the product of the capacitance C, the weight coefficient Wij(l), and the function δ by the negative voltage Vdd−.

Comparing the variables σij(l)+ and σij(l)−, the capacitance C and the weight coefficient Wij_(l) are common, while the function δ and the voltage components positive voltage Vdd+ and negative voltage Vdd− are different.

The function δ is shown in the following Equation (5) for the function that outputs a logic value according to the state s. For example, the function & takes the state s as an argument and outputs 0 as the solution when state s does not satisfy the given condition (false) and outputs 1 as the solution when the state s satisfies the given condition (true).

$$\begin{matrix}[ Equation 5 ] & \\ {δ}_{s} = \{ \begin{matrix}0 , & if a condition s is false \\ 1 , & if a condition s if true\end{matrix} & ( 5 )\end{matrix}$$

As shown in the following Equation (6), the function θ(x) is a step function. For example, 0 is output if the argument x is negative and 1 is output if the argument x is positive.

$$\begin{matrix}[ Equation 6 ] & \\ θ ( x ) = \{ \begin{matrix}0 , & ( x < 0 ) \\ 1 , & ( x ≧ 0 )\end{matrix} & ( 6 )\end{matrix}$$

Next, referring to Equation (3B), the change in membrane potential in the second phase will be described.

The change in membrane potential in the second phase is specified as a fixed value determined by the capacitance C and the period T.

By dividing both sides of equations (3A) and (3B) by the capacitance C respectively and substituting equations (4A) and (4B), the following equations (7A) and (7B) are obtained. Equations (7A) and (7B) become equations for the rate of change of the membrane potential.

The rate of change of the membrane potential is the slope of the graph, with time on the horizontal axis and membrane potential on the vertical axis.

$$\begin{matrix}[ Equation 7 ] & \\ & \end{matrix}$$

$$\frac{d}{dt} {v}_{i}^{( l )} ( t ) = \{ \begin{matrix}{\sum }_{j}^{N} {w}_{ij}^{( l )} {δ}_{{w}_{ij}^{( l )} ≧ 0} ( 1 - \frac{{v}_{i}^{( l )}}{{V}_{dd}^{+}} ) θ ( t - {t}_{j}^{( l - 1 )} ) + & when ( l - 1 ) T ≦ t < lT & ( 7 A ) \\ {w}_{ij}^{( l )} {δ}_{{w}_{ij}^{( l )} < 0} ( 1 - \frac{{v}_{i}^{( l )}}{{V}_{dd}^{-}} ) θ ( t - {t}_{j}^{( l - 1 )} ) , & & \\ \frac{1}{T} , & when lT ≦ t < ( l + 1 ) T & ( 7 B )\end{matrix}$$

By the way, the right-hand side of Equation (7A) is summarized and rewritten as in Equation (8) below.

$$\begin{matrix}[ Equation 8 ] & \\ {w}_{ij}^{( l )} ( 1 - ( \frac{{δ}_{{w}_{ij}^{( l )} ≧ 0}}{{V}_{dd}^{+}} + \frac{{δ}_{{w}_{ij}^{( l )} < 0}}{{V}_{dd}^{-}} ) {v}_{i}^{( l )} ) θ ( t - {t}_{j}^{( l - 1 )} ) & ( 8 )\end{matrix}$$

Assuming the period T to be 1, if a substitution to a portion of the equation is made using the following Equation (9), the above equations (3A) and (3B) can be converted to the following equations (10A) and (10B).

$$\begin{matrix}[ Equation 9 ] & \\ {V}_{syn}^{ij} := \frac{{δ}_{{w}_{ij}^{( l )} ≧ 0}}{{V}_{dd}^{+}} + \frac{{δ}_{{w}_{ij}^{( l )} < 0}}{{V}_{dd}^{-}} & ( 9 )\end{matrix}$$

$$\begin{matrix}[ Equation 10 ] & \\ & \end{matrix}$$

$$\frac{d}{dt} {v}_{i}^{( l )} ( t ) = \{ \begin{matrix}{\sum }_{j}^{N} {w}_{ij}^{( l )} ( 1 - {v}_{i}^{( l )} {V}_{syn}^{ij} ) θ ( t - {t}_{j}^{( l - 1 )} ) , & when ( l - 1 ) ≦ t < l & ( 10 A ) \\ 1 , & when lT ≦ t < ( l + 1 ) T & ( 10 B )\end{matrix}$$

Equations (10A) and (10B) above are equivalent because they are the same as Equation (1a) above with the period T set to 1. In other words, after training the neural network based on Equation (1a), the same operation can be realized on the circuit as represented by equations (10A) and (10B).

The following is a summary of the movement of each portion.

By turning on the switch S31 and turning off the switch S32, the index value calculation portion 110 calculates the membrane potential vi(l)(t) for each interval based on equations (3A) and (3B) above. In the input time interval, the index value calculation portion 110 changes the membrane potential vi(l)(t) at a rate of change according to the input status of the spike signal to the target model as shown in Equations (1A) and (3A).

On the other hand, in the output time interval where the switch S31 is turned OFF and the switch S32 is turned ON, the index value calculation portion 110 blocks the spike signal by the switch S31. The index value calculation portion 110 does not accept spike signals to the target model as shown in Equation (1A).

Furthermore, in the output time interval, the index value calculation portion 110 varies the membrane potential vi(l)(t) based on the membrane potential vi(l)(lT) at the end of the input time interval and the elapsed time since the start of the output time interval. For example, by turning ON the switch S32, the index value calculation portion 110 charges the capacitor CP with a constant current to monotonically increase the membrane potential vi(l)(lT) from the membrane potential at the end of the input time interval. The formula shown in Equation (3B) is an example. The rate of change of the membrane potential vi(l)(t) during the output time interval should be maintained at a predetermined value decided in advance.

The comparison portion 120 compares the membrane potential vi(l)(t) with the threshold value Vth to determine whether the membrane potential vi(l)(t) has reached the threshold value Vth. For example, this comparison is performed over at least an output time interval. Alternatively, this comparison is performed at all times, and the results of the comparison are used at least for the output time interval.

The signal output portion 130 outputs a spike signal within the output time interval based on the results of the determination of the membrane potential vi(l)(t). For example, the signal output portion 130 outputs a spike signal when the membrane potential vi(l)(t) reaches the threshold Vth within the output time interval. If the membrane potential vi(l)(t) does not reach the threshold Vth within the output time interval, the signal output portion 130 may output a spike signal at the end of the output time interval.

For the output layer in the example in FIG. 5A, since there is no partner to pass the spike signal to, the spike can be output even in the time interval corresponding to the input time interval. The time interval corresponding to the input time interval in this case is also referred to as the input-output time interval.

Hereinbelow, with reference to FIG. 5B, the change in the membrane potential vi(l)(t) of the neuron model 100 is divided into several cases and explained.

FIG. 5B shows an example of a spike signal passed from layer l to layer l+1 of the neural network 11. The horizontal axis of the graph in FIG. 5B shows the time, i.e., the time elapsed since the first input data was entered in layer l. The vertical axis shows, from the top side of FIG. 5B, the membrane potential of the neuron model 100 in layer l and the output spike thereof, and the membrane potential vi(l)(t) of the neuron model 100 in layer l+1. In this FIG. 5B, interval A represents the input time interval and interval B represents the output time interval.

CASE 0 to CASE 2 in FIG. 5B show typical cases when the membrane potential vi(l)(t) reaches the threshold Vth. CASE 1 shows the case when the membrane potential vi(l)(t) reaches the threshold Vth within the output time interval. CASE0 and CASE2 show the cases in which the membrane potential vi(l)(t) reaches the threshold Vth within the input time interval.

For example, as shown in CASE 1 in FIG. 5B, if the membrane potential vi(l)(t) reaches the threshold Vth within the output time interval, the comparison portion 120 determines that the membrane potential vi(l)(t) has reached the threshold Vth. The signal output portion 130 outputs a spike signal based on the determination result of the comparison portion 120. As a result, the signal output portion 130 outputs a spike signal at the timing when the membrane potential vi(l)(t) has reached the threshold value Vth.

In contrast, as shown in CASE0 and CASE2 in FIG. 5B, even if a case arises where the membrane potential vi(l)(t) reaches the threshold Vth within the input time interval, at least the signal output portion 130 does not respond thereto and does not output a spike signal. In the case of CASE 0, the membrane potential vi(l)(t) drops below the threshold Vth at the end of the input time interval. In this case, the above CASE 1 case applies, and the signal output portion 130 outputs a spike signal at the timing when the membrane potential vi(l)(t) reaches the threshold Vth during the output time interval. In CASE 2, the membrane potential vi(l)(t) exceeds the threshold Vth at the end of the input time interval. In this case, the above case of CASE 1 is also applied, and the signal output portion 130 outputs a spike signal at the timing of the beginning of the output time interval when the membrane potential vi(l)(t) reaches the threshold Vth.

For example, the membrane potential vi(l)(t) may never reach the threshold Vth by the end of the output time interval. This is called CASE 3. In CASE 3, the comparison portion 120 may output a dummy determination result that the membrane potential has reached the threshold value. The signal output portion 130 may then output a spike signal at the end of the output time interval based on the determination result of the comparison portion 120.

Alternatively, in the case of CASE 3, the index value calculation portion 110 may calculate the membrane potential vi(l)(t) as 0 at the beginning of the next input time interval. This may allow the index value calculation portion 110 to start processing for the next data in the next input time interval from the state in which the membrane potential vi(l)(t) is reset to 0.

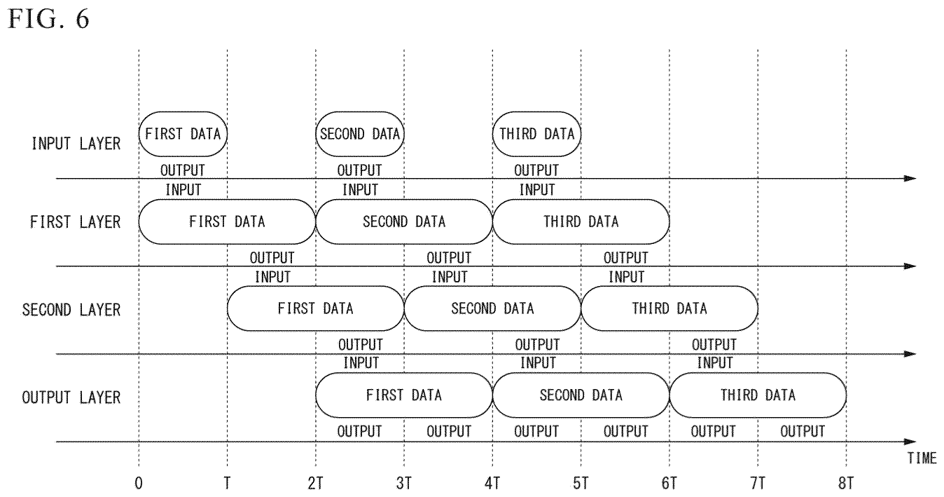

FIG. 6 is a diagram showing an example of the setting of a time interval. The horizontal axis in FIG. 6 shows time as the time elapsed from the start of data input to the neural network 11. Data input/output between layers is performed by spike signal input/output.

In the example in FIG. 6, the time shown on the horizontal axis is divided into time segments for each time T. FIG. 6 also shows the types of time intervals for each of the input layer, first layer, second layer, and output layer. Specifically, the input time interval is indicated by the description “input” and the output time interval is indicated by the description “output”. The input-output time interval is also shown with both “input” and “output” descriptions.

FIG. 6 also shows an example of the neural network 11 processing three sets of data: first data, second data, and third data. For each layer, the time interval for processing each data in that layer is shown.

In the example in FIG. 6, any of the neuron models 100 in the first layer, second layer, and third layer operate so as to complete the processing of data within one input time interval, one output time interval following that input time interval, and the data processing time. Specifically, each neuron model 100 outputs a spike signal and terminates the process if the membrane potential vi(l)(t) does not reach the threshold Vth by the end of the output time interval.

This allows the neuron model 100 to process the next data in the next data processing time. The entire neural network 11 can start processing the next data without waiting for the completion of processing the input data, so to speak, as in a pipeline process.

In the example in FIG. 6, the neural network device 10 synchronizes the layers and the neuron models 100 within each layer so that the output time interval of the layer on the side that outputs the spike signal and the input time interval of the layer that receives the input of that spike signal coincide. In other words, the neural network device 10 synchronizes the synchronization between layers and the neuron models 100 within each layer so that the output time interval of the layer on the side that outputs the spike signal completely overlaps with the input time interval of the layer that receives the input of that spike signal.

The neural network device 10 may include a synchronization processing portion, which notifies each neuron model 100 of the timing of switching between time intervals. Alternatively, each of the neuron models 100 may detect the timing of the switching between time intervals based on a clock signal common to all the neuron models 100.

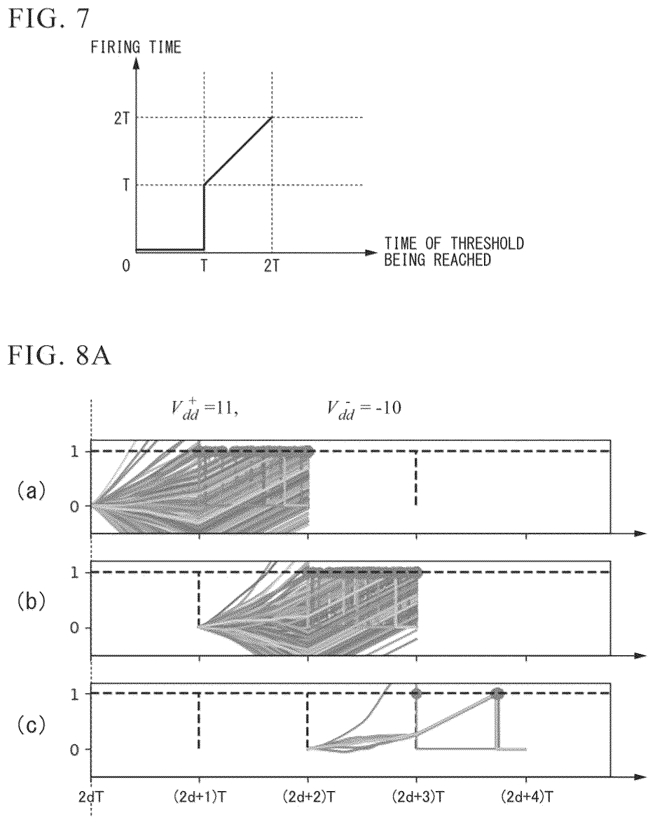

FIG. 7 is a diagram showing a setting example of the firing limit of the neuron model 100. FIG. 7 shows an example of a firing limit when the first layer neuron model 100 processes the first data in the example in FIG. 6. The horizontal axis of the graph in FIG. 7 shows the time when the membrane potential vi(l)(t) reaches the threshold Vth, in terms of the time elapsed since the start of data input to the neural network 11. The vertical axis indicates the time at which the neuron model 100 outputs the spike signal in terms of the time elapsed since the start of data input to the neural network 11. Either of the horizontal and vertical axes in FIG. 7 can be mapped to the horizontal axis in FIG. 6.

As shown in FIG. 7, if the threshold arrival time ti(l, vth) is earlier than time T, the neuron model 100 does not respond to it.

If the threshold arrival time ti(l, vth) is within the interval from time T to 2T, the neuron model 100 outputs a spike signal at the threshold arrival time ti(l, vth). Time 2T is the end of the output time interval. The delay time between the membrane potential vi(l)(t) reaching the threshold Vth and the output of the spike signal by the neuron model 100 is assumed to be negligible.

If the threshold arrival time ti(l, vth) is later than the time 2T, i.e., the membrane potential vi(l)(t) does not reach the threshold Vth by the time 2T, the neuron model 100 either outputs a spike signal at time 2T or moves on to process the next data without outputting a spike signal.

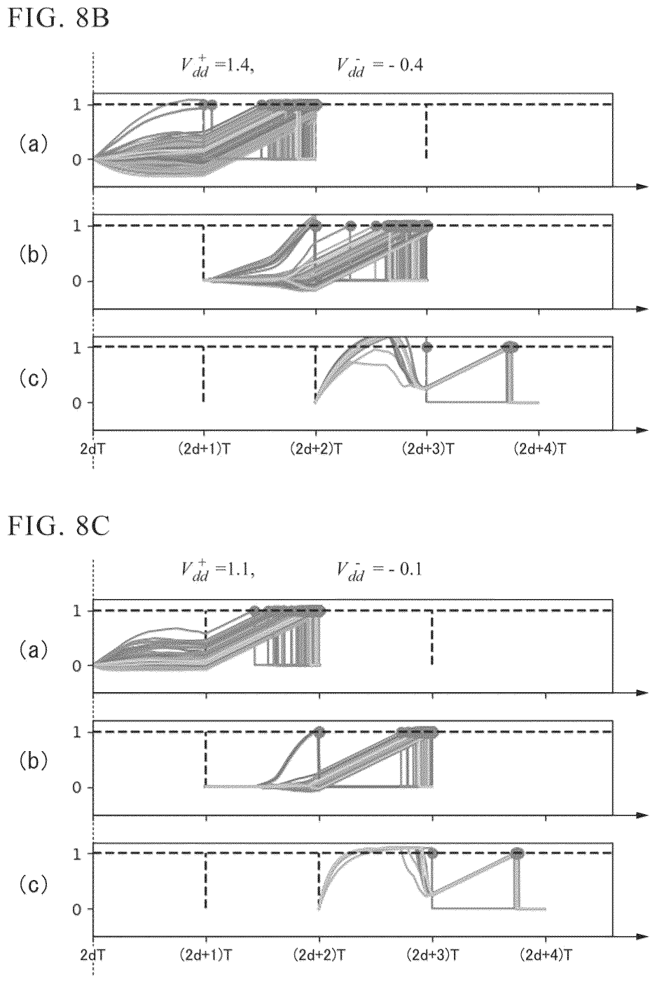

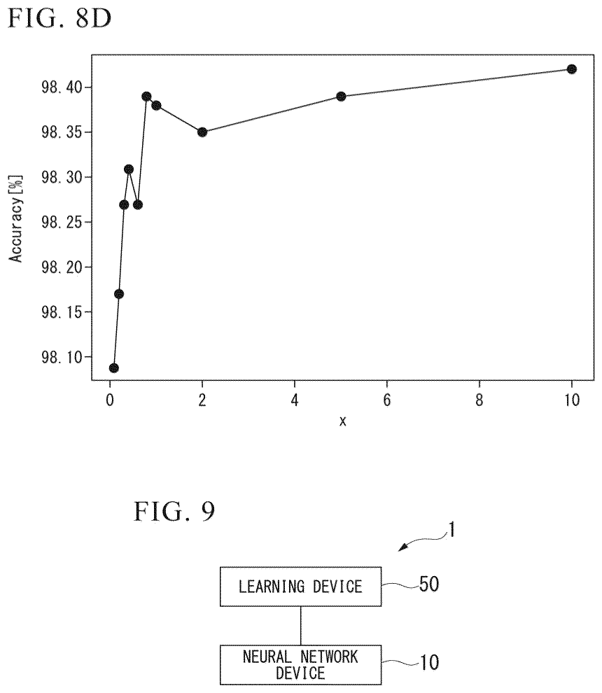

Referring to FIGS. 8A through 8D, the response of the neuron model 100 will be described. FIGS. 8A through 8C are diagrams illustrating the response of the neuron model 100. FIG. 8D illustrates the operation of the neuron model 100.

The results of the experiments using the neural network device 10, shown in FIGS. 8A through 8D, are based on training and testing the recognition of handwritten numeral images using MNIST, which is a data set of handwritten numeral images.

The neural network 11 used in this test was a fully connected feed-forward type with four layers: an input layer, a first layer, a second layer, and an output layer. The number of neuron models 100 in the input layer was set to 784, the number of neuron models 100 in the first and second layers was set to 200 each, and the number of neuron models 100 in the output layer was set to 10.

The horizontal and vertical axes of the graphs in FIGS. 8A through 8C correspond to FIG. 5A and show the time when the membrane potential vi(l)(t) reaches the threshold Vth in terms of the time elapsed since the start of data input to the neural network 11. The vertical axis indicates the time at which the neuron model 100 output a spike signal in terms of the time elapsed from the start of data input to the neural network 11.

The difference between the figures in FIGS. 8A through 8C is that the reference voltages (positive voltage Vdd+ and negative voltage Vdd−) output by the power supply PS, which is a constant voltage source, are different from each other. For example, the positive voltage Vdd+ in FIG. 8A is +11 V (volts) and the negative voltage Vdd− is −10 V. The positive voltage Vdd+ in FIG. 8B is +1.4 V and the negative voltage Vdd− is −0.4 V. The positive voltage Vdd+ in FIG. 8C is +1.1 V and the negative voltage Vdd− is −0.1 V.

The example shown in FIG. 8A corresponds to the case where the reference voltage is sufficiently high among these three examples. By increasing the reference voltage, the current flowing into or out of the membrane potential becomes relatively independent of the value of the membrane potential. Therefore, the value of the membrane potential at the end of the input time interval is almost identical to the result of the sum-of-products computation. The desired identification results are obtained at the output layer stage shown in (c) of FIG. 8A.

In contrast, the two examples shown in FIGS. 8B and 8C correspond to cases where the reference voltage is relatively low. By keeping the reference voltage relatively low, power consumption and heat generation in the circuit through which the signal passes can be reduced. In these examples, the current value is highly dependent on the value of the membrane potential, which is characterized by a gentle slope as the membrane potential approaches the reference voltage. Also, in these examples, the value of the membrane potential at the end of the input time interval does not match the result of the sum-of-products computation result, but as discussed below, the learning performance is hardly degraded. In the output layer stage shown in (c) of FIG. 8B and FIG. 8C, the desired identification results are obtained.

FIGS. 8A through 8C above are examples of verification results, and the reference voltage can be set accordingly. FIG. 8D shows the results of a comparison of recognition performance for several cases in which the reference voltage was adjusted in this way.

The horizontal axis of FIG. 8D shows the absolute value of the positive voltage Vdd+ and negative voltage Vdd−, while the vertical axis shows the accuracy rate of the identification results (recognition performance). It was confirmed that if the reference voltage is not set extremely low, its recognition performance is comparable to that of the ideal weighted sum model.

FIG. 9 is a diagram showing an example of the system configuration during training. In the configuration shown in FIG. 9, the neural network system 1 includes the neural network device 10 and a learning device 50. The neural network device 10 and the learning device 50 may be integrally configured as one device. Alternatively, the neural network device 10 and the learning device 50 may be configured as separate devices.

As mentioned above, the neural network 11 that the neural network device 10 comprises is also referred to as the neural network body.

The neural network device 10 in neural network system 1 includes an index value calculation portion 110 (current adding portion), i.e., the neuron model 100. As described above, the index value calculation portion 110 is formed so that the current flowing into or out of the neuron model 100 (own neuron) during the accumulation phase depends on the membrane potential of the neuron model 100.

For example, the process of computing the membrane potential of the neuron model 100 by the index value calculation portion 110 includes a current adding computation in which the current flowing into or out of the neuron model 100 depends on the membrane potential of the neuron model 100. The learning device 50 generates a trained model for determining the responsiveness of the membrane potential of the neuron model 100 to the aforementioned current.

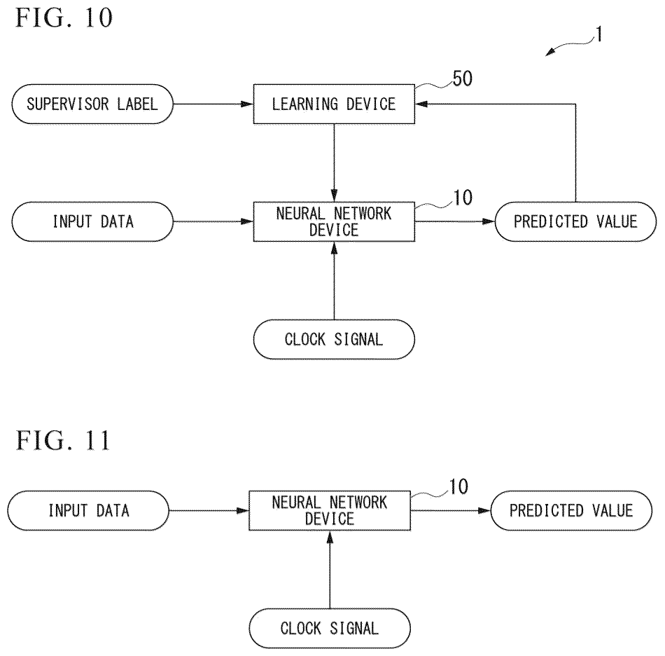

FIG. 10 is a diagram showing an example of signal input/output in the neural network system 1. In the example in FIG. 10, input data and a supervisor label indicating the correct answer to the input data are input to the neural network system 1. The neural network device 10 may receive the input of the input data, and the learning device 50 may receive the input of the supervisor label. The combination of the input data and supervisor label corresponds to an example of training data in supervised learning.

The neural network device 10 also acquires a clock signal. The neural network device 10 may be equipped with a clock circuit. Alternatively, the neural network device 10 may receive a clock signal input from outside the neural network device 10.

The neural network device 10 receives input data and outputs an estimated value based on the input data. When calculating the estimated value, the neural network device 10 uses a clock signal to synchronize time intervals between layers and between neuron models 100 in the same layer.

The learning device 50 performs learning of the neural network device 10. Learning here refers to adjusting the parameter values of the learning model by machine learning. The learning device 50 performs learning of a weight coefficient for the spike signal input to the neuron model 100. The weight Wij(l) in Equation (4) corresponds to an example of a weight coefficient whose value is adjusted by the learning device 50 through training. The weight Wij(l) in Equation (4) corresponds, for example, to the conductance of the analog circuit.

The learning device 50 may perform learning of weight coefficients so that the magnitude of the error between the estimated value and the correct value indicated by the supervisor label is reduced, using an evaluation function that indicates an evaluation of the error between the estimated value output by the neural network device 10 and the correct value.

The learning device 50 is an example of a learning means. The learning device 50 is composed of, for example, a computer.

For example, machine learning methods, reinforcement learning methods, deep reinforcement learning methods, and the like may be applied as the learning method by the learning device 50. More specifically, the learning device 50 may learn the characteristic value of the indicator value calculation portion 110 so that the predetermined gain is maximized, following the method of reinforcement learning (deep reinforcement learning).

Existing learning methods such as error back propagation, for example, can be used as the learning method performed by the learning device 50.

For example, when the learning device 50 performs learning using the error backpropagation method, the weight Wij(l) may be updated so that the weight Wij(l) is changed by the change amount ΔWij(l) shown in Equation (11).

$$\begin{matrix}[ Equation 11 ] & \\ Δ {w}_{ij}^{( l )} = - η \frac{\partial C}{\partial {w}_{ij}^{( l )}} & ( 11 )\end{matrix}$$

n is a constant that indicates the learning rate. The learning rates in Equation (11) may be the same or different from each other.

C is expressed as in Equation (12).

$$\begin{matrix}[ Equation 12 ] & \\ C := - {\sum }_{i = 1}^{{N}^{( M )}} {κ}_{i} ln ( {S}_{i} ( {t}^{( M )} ) ) + \frac{γ}{2} {( {{t}_{i}}^{* ( M )} - {t}^{( ref )} )}^{2} & ( 12 )\end{matrix}$$

The first term in C corresponds to an example of an evaluation function that indicates the evaluation for errors between the estimated value output by the neural network device 10 and the correct value indicated by the supervisor label. The first term in C is set as a loss function that outputs a smaller value the smaller the error.

M represents an index value indicating the output layer (final layer). N (M) represents the number of neuron models 100 included in the output layer.

κi represents the supervisor label. Let us assume that the neural network device 10 performs class classification with N (M) classes, and that the supervisor label is denoted by one-hot vector. It is assumed that κi=1 when the value of index i indicates the correct class, and κi=0 otherwise.

t(ref) represents the reference spike.

The term “γ/2(ti(M)−t(ref))2” is a term provided to avoid learning difficulties. This term is also called the Temporal Penalty Term. γ is a constant to adjust the influence of the Temporal Penalty Term, which γ being greater than zero. γ is also called the Temporal Penalty Coefficient.

Si is a softmax function and is expressed as in Equation (13).

$$\begin{matrix}[ Equation 13 ] & \\ {S}_{i} ( {t}^{( M )} ) := \frac{exp ( - \frac{{{t}_{i}}^{* ( M )}}{{σ}_{soft}} )}{{\sum }_{j = 1}^{{N}^{( M )}} exp ( - \frac{{{t}_{j}}^{* ( M )}}{{σ}_{soft}} )} & ( 13 )\end{matrix}$$

σsoft is a constant established as a scale factor to adjust the magnitude of the value of the softmax function Si, where σsoft >0.

For example, the spike firing time of the output layer may indicate, for each class, the probability that the classified object indicated by the input data is classified into that class. For i where κi=1, the smaller the value of ti(M), the smaller the term “−Σi=1N(M) (κiln(Si(t(M))))”, and so the learning device 50 calculates the loss (the value of the evaluation function C) smaller.

However, the processing performed by the neural network device 10 is not limited to class classification.

FIG. 11 is a diagram showing an example of signal input/output in the neural network device 10 during operation.

As in the operation shown in FIG. 10, during learning, the neural network device 10 receives input data and also acquires a clock signal. The neural network device 10 may be equipped with a clock circuit. Alternatively, the neural network device 10 may receive a clock signal input from outside the neural network device 10.

The neural network device 10 receives the input of input data and outputs an estimated value based on the input data. When calculating the estimated value, the neural network device 10 may use a clock signal to synchronize time intervals between layers and between neuron models 100 in the same layer.

According to an example embodiment, the neural network device 10 (computing device) includes a spiking neural network (neural network 11) that includes an accumulation phase that adds currents and a decoding phase that converts the voltage produced by the addition to a voltage pulse timing. The spiking neural network includes an index value calculation portion 110 (current adding portion) where the current that flows into or out of the neuron model 100 during the accumulation phase depends on the membrane potential of the neuron model 100 in question. This allows each of the neuron models 100 that make up the neural network device 10 to be configured more simply.

In addition, current flows to the index value calculation portion 110 by the output of the preceding neuron provided in front of the neuron model 100. The current that that preceding neuron sends to the index value calculation portion may depend on the potential difference between the reference voltage of the preceding neuron and the membrane potential of the index value calculation portion 110.

In addition, because the current that the preceding neuron sends to the index value calculation portion 110 is proportional to the potential difference between the reference voltage of the preceding neuron and the membrane potential of the neuron model 100, the result of that computation, the reference voltage of the preceding neuron, affects the current that the preceding neuron sends to the index value calculation portion 110. By taking these effects into account and incorporating them into the learning process, high learning performance can be maintained.

The index value calculation portion 110 may be trained to reduce the magnitude of the current flowing due to the output of the preceding neuron through learning with a predetermined arbitrary cost function.

Furthermore, the index value calculation portion 110 may learn conductance characteristics related to the magnitude of the current flowing due to the output of the preceding neuron through learning using an arbitrary predetermined cost function.

### Modification of Example Embodiment

When the neural network 11 is configured as a feed-forward spiking neural network, as described above, the number of layers of the neural network 11 need only be two or more, and is not limited to a specific number of layers. The number of neuron models 100 that each layer has is not limited to a specific number; each layer can have one or more neuron models 100. Each layer may have the same number of neuron models 100, or different layers may have different numbers of neuron models 100. The neural network 11 may or may not be fully-connected. For example, the neural network 11 may be configured as a convolutional neural network (CNN) with a spiking neural network.

The membrane potential after the firing of each neuron model 100 is not limited to remaining constant at the aforementioned potential of 0. For example, for a predetermined time from firing, the membrane potential may change in response to the spike signal input. The number of times each of the neuron models 100 fires is also not limited to once per input data.

The configuration of the neuron model 100 as a spiking neuron model is also not limited to any particular configuration. For example, the rate of change in the membrane potential of the neuron model 100 may not be constant from the receipt of one spike signal input to the receipt of the next spike signal input.

The learning method of the neural network 11 is not limited to supervised learning. The learning device 50 may perform unsupervised training of the neural network 11.

As described above, the index value calculation portion 110 varies the membrane potential over time based on the input status of the signal in the input time interval. The signal output portion 130 outputs a signal within the output time interval after the end of the input time interval based on the membrane potential.

By setting the input time interval during which the neuron model 100 accepts spike signal inputs and the output time interval during which the neuron model 100 outputs spike signals, the time during which the index value calculation portion 110 should calculate the membrane potential can be limited to the time from the start of the input time interval to the end of the output time interval. At other times, the neuron model 100 can perform processing on other data.

According to the neural network device 10, the spiking neural network can efficiently process data in this regard.

Furthermore, the index value calculation portion 110 changes the membrane potential at a rate of change that depends on the signal input status during the input time interval. If the membrane potential does not reach the threshold value within the input time interval, the index value calculation portion 110 changes the membrane potential at a predetermined rate of change during the output time interval.

If the membrane potential reaches the threshold value within the output time interval, the signal output portion 130 outputs a spike signal when the membrane potential reaches the threshold value. If the membrane potential does not reach the threshold within the output time interval, the signal output portion 130 outputs a spike signal at the end of the output time interval.

This allows the neuron model 100 to limit the time during which the spike signal is output to the output time interval. After the end of the output time interval, the neuron model 100 can perform processing on other data.

According to the neural network device 10, the spiking neural network can efficiently process data in this regard.

The output time interval and input time interval are set so that the output time interval of the first neuron model 100 overlaps the input time interval of the second neuron model that receives the spike signal input from the first neuron model 100.

This allows data to be efficiently transmitted by spike signals from the first neuron model 100 to the second neuron model 100, and the first neuron model and the second neuron model 100 can perform processing in a pipeline-like manner.

According to the neural network device 10, the spiking neural network can efficiently process data in this regard.

The index value calculation portion 110 varies the membrane potential over time based on the input status of the signal in the input time interval. The signal output portion 130 outputs a spike signal within the output time interval after the end of the input time interval based on the membrane potential. The learning device 50 learns weight coefficients for spike signals.

This allows the weight coefficients to be adjusted through learning and improves the accuracy of estimation by the neural network device 10.

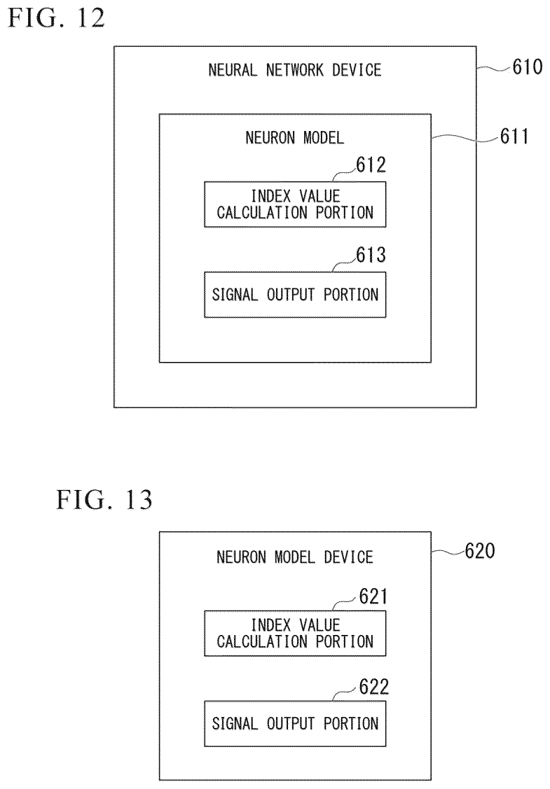

FIG. 12 is a diagram showing an example of the configuration of the neural network device according to the example embodiment. In the configuration shown in FIG. 11, a neural network device 610 has a neuron model 611. The neuron model 611 is equipped with an index value calculation portion 612 and a signal output portion 613.

In such a configuration, the neuron model 611 is formed to be able to transmit spikes by having them fire within a certain time interval. In the neural network device 610, the input time interval in which spikes are received and the output time interval in which spikes are allowed to be transmitted are demarcated in association with the firing of the neuron model 611.

For example, the index value calculation unit 612 varies the index value of the signal output based on the input status of the signal in the input time interval. The signal output portion 613 outputs a signal within the output time interval after the end of the input time interval by firing based on the index value.

The index value calculation portion 612 corresponds to an example of an index value calculation means. The signal output portion 613 corresponds to an example of a signal output means.

Thus, by setting the input time interval during which the neuron model 611 receives signal input and the output time interval during which the neuron model 611 outputs spike signals, and by causing the firing to occur in the output time interval, the time during which the index value calculation portion 612 should calculate the index value can be limited to the time from the start of the input time interval to the end of the output time interval. At other times, the neuron model 611 can perform processing on other data.

According to the neural network device 610, the spiking neural network can efficiently process data in this regard.

As long as the layers do not interfere with signal input and signal output, the input time interval and the output time interval may be specified so as to overlap. For example, the output layer 23 described above is an example of a layer where signal input and signal output do not interfere. The neuron model 611 applied to the output layer 23 may have an input-output time interval associated with firing, where signals are allowed to be received and transmitted. An input-output time interval during which signals are allowed to be received and transmitted may be set in place of an input time interval during which signal output is restricted.

FIG. 13 is a diagram showing an example of the configuration of a neuron model device according to the example embodiment. In the configuration shown in FIG. 13, the neuron model device 620 includes with an index value calculation portion 621 and a signal output portion 622.

In such a configuration, the neuron model device 620 is divided into an input time interval in which the signal is received and an output time interval in which the signal is allowed to be transmitted, in association with the firing. The index value calculation portion 621 varies the index value of the signal output based on the input status of the signal in the input time interval. The signal output portion 622 outputs a signal within the output time interval after the end of the input time interval by firing based on the index value.

The index value calculation portion 621 corresponds to an example of an index value calculation means. The signal output portion 622 corresponds to an example of a signal output means.

By setting the input time interval during which the neuron model device 620 accepts spike signal inputs and the output time interval during which the neuron model device 620 outputs spike signals, the time during which the index value calculation portion 621 should calculate the index value can be limited to the time from the start of the input time interval to the end of the output time interval. At other times, the neuron model device 620 can perform processing on other data.

According to the neuron model device 620, the spiking neural network can efficiently process data in this regard.

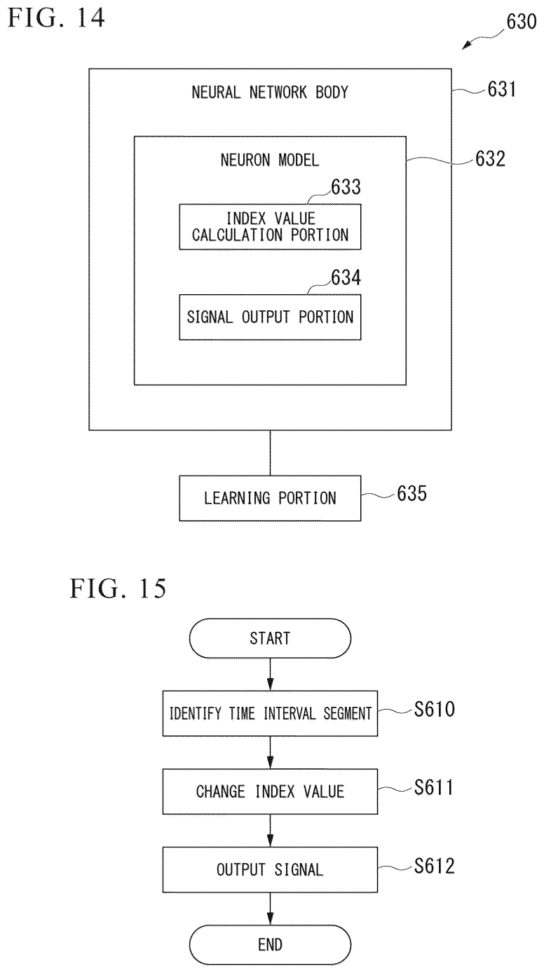

FIG. 14 is a diagram showing an example of the configuration of a neural network system according to the example embodiment.

In the configuration shown in FIG. 14, a neural network system 630 includes a neural network body 631 and a learning portion 635. The neural network body 631 includes a neuron model 632. The neuron model 632 includes an index value calculation portion 633 and a signal output portion 634.

In such a configuration, the neural network system 630 is divided into an input time interval in which the signal is received and an output time interval in which the signal is allowed to be transmitted, in association with the firing of the neuron model 632. The index value calculation portion 633 varies the index value of the signal output based on the input status of the signal in the input time interval. The signal output portion 634 outputs a signal within the output time interval after the end of the input time interval based on the index value. The learning portion 635 learns weight coefficients for signals input to the neuron model 632.

The index value calculation portion 633 corresponds to an example of an index value calculation means. The signal output portion 634 corresponds to an example of a signal output means. The learning portion 635 corresponds to an example of a learning means. The learning portion 635 is an example of a learning means that learns the characteristic values of the index value calculation portion 633 (current adding portion) so that the computation result of any predetermined cost function is minimized.

In the neural network system 630, this allows the weight coefficients to be adjusted through learning, improving the accuracy of estimation by the neural network body 631.

FIG. 15 is a flowchart showing an example of the processing steps in the computation method according to the example embodiment. The computation method shown in FIG. 15 includes identifying the time interval segment (Step S610), calculating the index value (Step S611), and outputting the signal (Step S612).

In identifying a time interval segment (Step S610), the input time interval in which a spikes is received and the output time interval in which a spike is allowed to be transmitted are identified. For example, identifying time interval segments may include setting flags according to the results of the identification. In calculating the index value (Step S611), if the result of the identification indicates an input time interval, the signal input is allowed and the index value of the signal output is changed based on the signal input status in the input time interval. Outputting a signal (Step S612) is performed in response to the detection of a transition from the input time interval to the output time interval, for example, by the result of the identification. In outputting a signal (Step S612), the signal is output within the output time interval after the end of the input time interval by firing based on the index value, depending on the result of identification (flag value).

In the computation method shown in FIG. 15, by setting the input time interval for receiving signal inputs and the output time interval for outputting signals, and causing the firing to occur within the output time interval, it is possible to limit the time when the index value should be calculated to the time from the start of the input time interval to the end of the output time interval. At other times, processing can be performed on other data.

The computation method shown in FIG. 15 allows the spiking neural network to process data efficiently in this regard.

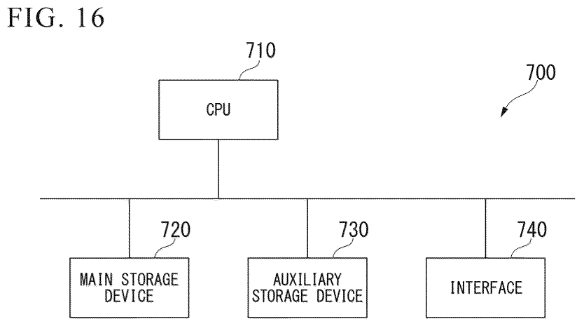

FIG. 16 is a schematic block diagram of at least one example embodiment of a computer.

In the configuration shown in FIG. 16, a computer 700 includes a CPU 710, main storage device 720, an auxiliary storage device 730, an interface 740, and a nonvolatile recording medium 750.

Any one or more of the above neural network device 10, learning device 50, neural network device 610, neuron model device 620, and neural network system 630, or parts thereof, may be implemented in the computer 700. In that case, the operations of each of the above-mentioned processing portions are stored in the auxiliary storage device 730 in the form of a program. The CPU 710 reads the program from the auxiliary storage device 730, deploys it in the main memory device 720, and executes the above processing according to the program. The CPU 710 also reserves a storage area in the main storage device 720 corresponding to each of the above-mentioned storage sections according to the program. Communication between each device and other devices is performed by the interface 740, which has a communication function and communicates according to the control of the CPU 710.

When the neural network device 10 is implemented in the computer 700, the operations of the neural network device 10 and the various parts thereof are stored in the auxiliary storage device 730 in the form of a program. The CPU 710 reads the program from the auxiliary storage device 730, deploys it in the main memory device 720, and executes the above processing according to the program.

The CPU 710 also reserves a storage area in the main storage device 720 for processing of the neural network device 10 according to the program. Communication between the neural network device 10 and other devices is performed by the interface 740, which has a communication function and operates according to the control of the CPU 710. Interaction between the neural network device 10 and the user is performed by the interface 740 being equipped with a display device and input device, displaying various images according to the control of the CPU 710, and accepting user operations.

When the learning device 50 is implemented in the computer 700, the operation of the learning device 50 is stored in the auxiliary storage device 730 in the form of a program. The CPU 710 reads the program from the auxiliary storage device 730, deploys it in the main memory device 720, and executes the above processing according to the program.

The CPU 710 also reserves a storage area in the main storage device 720 for the processing of the learning device 50 according to the program. Communication between the learning device 50 and other devices is performed by the interface 740, which has a communication function and operates according to the control of the CPU 710. Interaction between the neural network device 50 and the user is performed by the interface 740 being equipped with a display device and input device, displaying various images according to the control of the CPU 710, and accepting user operations.

When the neural network device 610 is implemented in the computer 700, the operations of the neural network device 610 and the various parts thereof are stored in the auxiliary storage device 730 in the form of a program. The CPU 710 reads the program from the auxiliary storage device 730, deploys it in the main memory device 720, and executes the above processing according to the program.

The CPU 710 also reserves a storage area in the main storage device 720 for processing of the neural network device 610 according to the program. Communication between the neural network device 610 and other devices is performed by the interface 740, which has a communication function and operates according to the control of the CPU 710. Interaction between the neural network device 610 and the user is performed by the interface 740 being equipped with a display device and input device, displaying various images according to the control of the CPU 710, and accepting user operations.

When the neuron model device 620 is implemented in the computer 700, the operations of the neuron model device 620 and the various parts thereof are stored in the auxiliary storage device 730 in the form of a program. The CPU 710 reads the program from the auxiliary storage device 730, deploys it in the main memory device 720, and executes the above processing according to the program.

The CPU 710 also reserves a storage area in the main memory 720 for the processing of the neuron model device 620 according to the program. Communication between the neuron model device 620 and other devices is performed by the interface 740, which has a communication function and operates according to the control of the CPU 710. Interaction between the neuron model device 620 and the user is performed by the interface 740 being equipped with a display device and input device, displaying various images according to the control of the CPU 710, and accepting user operations.

When the neural network system 630 is implemented in the computer 700, the operations of the neural network system 630 and the various parts thereof are stored in the auxiliary storage device 730 in the form of a program. The CPU 710 reads the program from the auxiliary storage device 730, deploys it in the main memory device 720, and executes the above processing according to the program.

The CPU 710 also reserves a storage area in the main storage device 720 for processing of the neural network system 630 according to the program. Communication between the neural network system 630 and other devices is performed by the interface 740, which has a communication function and operates according to the control of the CPU 710. Interaction between the neural network system 630 and the user is performed by the interface 740 being equipped with a display device and input device, displaying various images according to the control of the CPU 710, and accepting user operations.

A program for executing all or part of the processes performed by the neural network device 10, the learning device 50, the neural network device 610, the neuron model device 620, and the neural network system 630 may be recorded on a computer-readable recording medium, and by having the computer system read and execute the program recorded on this recording medium, the processing of each part may be performed by the computer system. The term “computer system” here shall include an operating system and hardware such as peripherals.

In addition, “computer-readable recording medium” means a portable medium such as a flexible disk, magneto-optical disk, ROM (Read Only Memory), CD-ROM (Compact Disc Read Only Memory), or other storage device such as a hard disk built into a computer system. The above program may be used to realize some of the aforementioned functions, and may also be used to realize the aforementioned functions in combination with programs already recorded in the computer system.

The above example embodiments of this invention have been described in detail with reference to the drawings. Specific configurations are not limited to these example embodiments, but also include designs, etc., to the extent that they do not depart from the gist of this invention.

### DESCRIPTION OF REFERENCE SIGNS

1, 630 Neural network system
10, 10A, 610 Neural network device
11, 11A Neural network
21 Input layer
22 Intermediate layer
23 Output layer
24 Feature extraction layer
50 Learning device
100, 611, 632 Neuron model
110, 612, 621, 633 Index value calculation portion
120 Comparison portion
130, 613, 622, 634 Signal output portion
620 Neuron model device
631 Neural network body
635 Learning portion

What is claimed is:

1. A computing device comprising a spiking neural network that includes an accumulation phase that adds currents and a decoding phase that converts a voltage resulting from the addition to a voltage pulse timing,
wherein the spiking neural network comprises a current adding portion wherein the current that flows into or out of an own neuron in the accumulation phase depends on membrane potential of that neuron.

2. The computing device according to claim 1, wherein current flows to the current adding portion by the output of a preceding neuron provided in front of the own neuron, and
the current that the preceding neuron sends to the current adding portion depends on the potential difference between the reference voltage of the preceding neuron and the membrane potential of the own neuron.

3. The computing device according to claim 2, wherein the current that the preceding neuron sends to the current adding portion is proportional to the potential difference between the reference voltage of the preceding neuron and the membrane potential of the own neuron.

4. The computing device according to claim 2, wherein the magnitude of the current flowing due to the output of the preceding neuron is learned by learning using a predetermined arbitrary cost function.

5. The computing device according to claim 2, wherein a conductance characteristic related to the magnitude of the current flowing due to the output of the preceding neuron is learned by learning using a predetermined arbitrary cost function.

6. The computing device according to claim 1, further comprising a learning means that learns a characteristic value of the current adding portion so that the calculation result of a predetermined arbitrary cost function is minimized.

7. A neural network system comprising a spiking neural network that includes an accumulation phase that adds currents and a decoding phase that converts a voltage resulting from the addition to a voltage pulse timing,
comprising a current adding portion wherein the current that flows into or out of an own neuron in the accumulation phase depends on the membrane potential of that neuron.

8. (canceled)

9. A computation method of controlling a computing device including an accumulation phase and a decoding phase of a spiking neural network, the method comprising:
adding current in the accumulation phase; and
converting a voltage resulting from the addition to a voltage pulse timing in the decoding phase,
wherein the current that flows into or out of an own neuron in the accumulation phase depends on membrane potential of that neuron.

10. (canceled)

11. The computing device according to claim 3, wherein the magnitude of the current flowing due to the output of the preceding neuron is learned by learning using a predetermined arbitrary cost function.

12. The computing device according to claim 3, wherein a conductance characteristic related to the magnitude of the current flowing due to the output of the preceding neuron is learned by learning using a predetermined arbitrary cost function.

13. The computing device according to claim 2, further comprising a learning means that learns a characteristic value of the current adding portion so that the calculation result of a predetermined arbitrary cost function is minimized.

14. The computing device according to claim 3, further comprising a learning means that learns a characteristic value of the current adding portion so that the calculation result of a predetermined arbitrary cost function is minimized.

15. The computing device according to claim 4, further comprising a learning means that learns a characteristic value of the current adding portion so that the calculation result of a predetermined arbitrary cost function is minimized.

16. The computing device according to claim 5, further comprising a learning means that learns a characteristic value of the current adding portion so that the calculation result of a predetermined arbitrary cost function is minimized.
